(19) United States
(12) Patent Application Publication
(10) Pub. No.: US 2026/0330245 A1
(43) Pub. Date: Oct. 22, 2026

(54) METHOD AND APPARATUS FOR DETERMINING BRAIN-INSPIRED APPLICATION TEST SUITE, ELECTRONIC DEVICE, AND STORAGE MEDIUM

(71) Applicant: TSINGHUA UNIVERSITY, Beijing (CN)

(72) Inventors: Youhui ZHANG, Beijing (CN); Zhe PAN, Beijing (CN); Yuxuan ZHANG, Beijing (CN)

(21) Appl. No.: 19/697,470

(22) Filed: Jun. 3, 2026

Related U.S. Application Data
(63) Continuation of application No. PCT/CN2023/136095, filed on Dec. 4, 2023.

(51) Int. Cl. G06N 3/10; G06F 11/3668; G06N 3/049

(52) U.S. Cl. CPC G06N 3/10; G06F 11/3672; G06N 3/049

(57) ABSTRACT

The present application discloses a method and an apparatus for determining a brain-inspired application test suite, an electronic device, and a storage medium. The method includes: performing feature analysis on each brain-inspired application included in an initial application test suite to obtain a data representation feature corresponding to each brain-inspired application; computing a computational overhead generated when each brain-inspired application is executed based on a spiking neural network paradigm; determining a data computation feature corresponding to each brain-inspired application according to the computational overhead; performing clustering processing on the brain-inspired applications in the initial application suite based on the data representation feature and the data computation feature, so that applications having similar features are merged into a same group, obtaining several groups whose main features are pairwise orthogonal; and constructing a representative spiking neural network according to a feature vector corresponding to each group.

### CROSS REFERENCE TO RELATED APPLICATION

The present application is a continuation application of International Application No. PCT/CN2023/136095 filed on Dec. 4, 2023, which is hereby incorporated by reference in its entirety.

### TECHNICAL FIELD

The present application belongs to the field of data processing, and particularly relates to a method and an apparatus for determining a brain-inspired application test suite, an electronic device, and a storage medium.

### BACKGROUND

Brain-inspired computing is a computing architecture that simulates the human brain and nervous system. Brain-inspired computing systems centering on brain-inspired computing chips are rapidly developing. To ensure the stable operation of a brain-inspired computing system, in practical applications, it is necessary to use brain-inspired applications in an application test suite to test the system performance of the brain-inspired computing system. To improve the efficiency of system performance testing, it is necessary to ensure that the computation features of the brain-inspired applications in the application test suite have orthogonality, i.e., the features corresponding to the brain-inspired applications in the application test suite are dissimilar.

However, in related technologies, the features of brain-inspired applications cannot be quantitatively analyzed, thus making it impossible to effectively streamline the application test suite. In addition, in related technologies, brain-inspired applications are also manually selected from different application scenarios to test the performance of a brain-inspired computing system. However, the brain-inspired applications included in an application test suite constructed in this way may not cover various scenarios, and may also include a large number of brain-inspired applications having the same features. Using an existing application test suite to test the performance of a brain-inspired computing system may result in low testing efficiency and poor testing accuracy of the brain-inspired computing system.

### SUMMARY

Embodiments of the present application provide a method and an apparatus for determining a brain-inspired application test suite, an electronic device, and a storage medium, which can streamline an application test suite, thereby ensuring orthogonality among brain-inspired applications included in the application test suite.

In a first aspect, an embodiment of the present application provides a method for determining a brain-inspired application test suite. The method includes: performing feature analysis on each brain-inspired application included in an initial application test suite to obtain a data representation feature corresponding to each brain-inspired application; computing a computational overhead generated when each brain-inspired application is executed based on a spiking neural network paradigm; determining a data computation feature corresponding to each brain-inspired application according to the computational overhead corresponding to each brain-inspired application; performing clustering processing on the brain-inspired applications in the initial application test suite based on the data representation feature of each brain-inspired application and the data computation feature of each brain-inspired application to obtain at least one group; and constructing a brain-inspired application according to a feature vector corresponding to each group to obtain a target application test suite corresponding to the initial application test suite, wherein multiple brain-inspired applications in the target application test suite have orthogonality.

In a second aspect, an embodiment of the present application provides an apparatus for determining a brain-inspired application test suite. The apparatus includes: a feature extraction module configured to perform feature analysis on each brain-inspired application included in an initial application test suite to obtain a data representation feature corresponding to each brain-inspired application; a computational overhead analysis module configured to compute a computational overhead generated when each brain-inspired application is executed based on a spiking neural network paradigm; a feature determination module configured to determine a data computation feature corresponding to each brain-inspired application according to the computational overhead corresponding to each brain-inspired application; a clustering module configured to perform clustering processing on the brain-inspired applications in the initial application test suite based on the data representation feature of each brain-inspired application and the data computation feature of each brain-inspired application to obtain at least one group; and a test suite determination module configured to construct a brain-inspired application according to a feature vector corresponding to each group to obtain a target application test suite corresponding to the initial application test suite, wherein multiple brain-inspired applications in the target application test suite have orthogonality.

In a third aspect, an embodiment of the present application provides an electronic device. The electronic device includes: a processor and a memory storing computer program instructions; wherein the processor executes the computer program instructions to implement the method for determining a brain-inspired application test suite as described in the first aspect.

In a fourth aspect, an embodiment of the present application provides a computer-readable storage medium having computer program instructions stored thereon, wherein the computer program instructions, when executed by a processor, implement the method for determining a brain-inspired application test suite as described in the first aspect.

In a fifth aspect, an embodiment of the present application provides a computer program product, wherein instructions in the computer program product, when executed by a processor of an electronic device, cause the electronic device to perform the method for determining a brain-inspired application test suite as described in the first aspect.

From the above content, it can be seen that the embodiments of the present application perform feature extraction on the brain-inspired application from multiple levels by extracting the data representation feature and the data computation feature of the brain-inspired application, thereby achieving quantitative analysis of the features of the brain-inspired application and providing a technical basis for streamlining an application test suite. In addition, in the embodiments of the present application, the brain-inspired applications in the target application test suite are constructed from the feature vectors of the groups, and the groups are obtained by performing clustering analysis on the brain-inspired applications in the application test suite based on the features of the brain-inspired applications, i.e., the brain-inspired applications included in a group have the same or similar features. Therefore, constructing brain-inspired applications based on the feature vectors of the groups obtained by clustering analysis can obtain a smaller number of brain-inspired applications, and these brain-inspired applications have orthogonality, thereby streamlining the application test suite. Using this streamlined application test suite to test the performance of a brain-inspired computing system can improve the testing efficiency of the brain-inspired computing system and enhance testing accuracy.

### BRIEF DESCRIPTION OF THE DRAWINGS

In order to more clearly illustrate the technical solutions of the embodiments of the present application, the drawings to be used in the embodiments of the present application will be briefly introduced below. For those of ordinary skill in the art, other drawings can be obtained based on these drawings without inventive effort.

FIG. 1 is a schematic diagram of an analysis framework provided by an embodiment of the present application;

FIG. 2 is a schematic flowchart of a method for determining a brain-inspired application test suite provided by an embodiment of the present application;

FIG. 3 is a schematic diagram of a brain-inspired application provided by an embodiment of the present application;

FIG. 4 is a schematic diagram of partitioning a brain-inspired application into blocks provided by an embodiment of the present application;

FIG. 5 is a schematic diagram corresponding to an SNN execution level provided by an embodiment of the present application;

FIG. 6 is a schematic structural diagram of an apparatus for determining a brain-inspired application test suite provided by another embodiment of the present application; and

FIG. 7 is a schematic structural diagram of an electronic device provided by yet another embodiment of the present application.

### DETAILED DESCRIPTION

Features and exemplary embodiments of various aspects of the present application will be described in detail below. In order to make the objects, technical solutions and advantages of the present application clearer, the present application is further described in detail below with reference to the accompanying drawings and specific embodiments. It should be understood that the specific embodiments described herein are only used to explain the present application, but not to limit the present application. For those skilled in the art, the present application can be implemented without some of these specific details. The following description of the embodiments is merely to provide a better understanding of the present application by illustrating the examples of the present application.

It should be noted that, in the present application, the relational terms, such as first and second, are used merely to distinguish one entity or operation from another entity or operation, without necessarily requiring or implying any actual such relationships or orders for these entities or operations. Moreover, the terms “comprise”, “include”, or any other variants thereof, are intended to represent a non-exclusive inclusion, such that a process, method, article or device including a series of elements includes not only those elements, but also other elements that are not explicitly listed or elements inherent to such a process, method, article or device. Without more constraints, the elements following an expression “comprise/include . . . ” do not exclude the existence of additional identical elements in the process, method, article or device that includes the elements.

To facilitate understanding, before explaining the solutions provided by the present application, the background of the solutions provided by the present application will be explained first.

Brain-inspired computing is a high-degree cross-integration of life science, especially brain science, and information technology. Its technical connotation includes an in-depth understanding of the brain's information processing principles, developing new processors, algorithms, and system integration architectures based on this understanding, and applying them to a wide range of fields such as new-generation artificial intelligence, big data processing, and human-computer interaction.

SNN (Spiking Neural Network) is the main computational paradigm of brain-inspired computing systems and one of the important computational paradigms for the next generation of neural networks. Various brain-inspired computing systems centering on brain-inspired computing chips are rapidly developing, gradually showing advantages in processing certain intelligent problems and low-power intelligent computing, with brain-inspired applications as the main objects.

However, there is currently a lack of a recognized and highly representative benchmark application test suite for brain-inspired applications. This benchmark application test suite should be composed of brain-inspired applications with high discriminability, so that using the brain-inspired applications in the benchmark application test suite can achieve an accurate evaluation of the system performance of a brain-inspired computing system.

From the above content, constructing the above-mentioned benchmark application test suite requires ensuring orthogonality among the application features of the selected brain-inspired applications, i.e., the application features of different brain-inspired applications in the benchmark application test suite are not identical or similar. Therefore, before constructing the above-mentioned benchmark application test suite, it is necessary to extract and analyze the features of brain-inspired applications to determine the similarity among various brain-inspired applications. If multiple brain-inspired applications are similar, they are clustered into one group; otherwise, they are clustered into different groups.

However, currently, the related art cannot achieve quantitative analysis of the features of various brain-inspired applications, which makes the brain-inspired applications in the benchmark application test suite not streamlined, thereby leading to low testing efficiency and poor testing accuracy of brain-inspired computing systems. Currently, the design of a benchmark application test suite urgently requires a suitable set of application feature extraction and analysis solutions to serve as a strong basis for selecting brain-inspired applications.

Given that most brain-inspired applications can be uniformly represented as SNNs, to address the above issue, the solutions provided by the embodiments of the present application can achieve feature extraction and feature analysis for brain-inspired applications. Based on a software/hardware decoupling concept, an analysis framework based on a parallel model is designed to achieve quantitative analysis of application features of brain-inspired applications, and then to evaluate the similarity among brain-inspired applications based on the features corresponding to the brain-inspired applications, providing a basis for streamlining the brain-inspired applications in an application test suite.

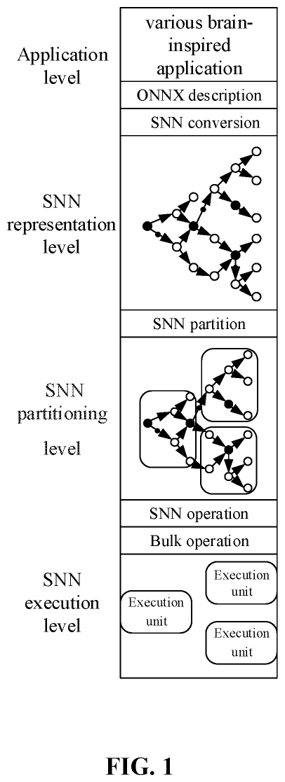

FIG. 1 shows an analysis framework provided by an embodiment of the present application. This analysis framework is constructed based on an SDF (Synchronous Dataflow Model) and a BSP (Bulk Synchronous Parallel) model. This analysis can realize feature abstraction of brain-inspired applications and brain-inspired architectures, thereby obtaining features of brain-inspired applications.

As shown in FIG. 1, the analysis framework consists of four levels: an application level, an SNN representation level, an SNN partitioning level, and an SNN execution level.

As shown in FIG. 1, at the SNN representation level, feature abstraction of a brain-inspired application is performed by an SNN conversion module to obtain an SDF representation of the brain-inspired application. Then, at the SNN partitioning level, the brain-inspired architecture of the brain-inspired application is abstracted into a BSP model. At the SNN execution level, based on a Bulk architecture (Bulk operation as shown in FIG. 1), multiple execution units are used to simulate the execution of the brain-inspired application (i.e., SNN execution in FIG. 1).

At the application level, ONNX (Open Neural Network Exchange) format is used as the representation and storage format for SNN to represent brain-inspired applications. Based on this, in the embodiments of the present application, the SNN representation level and the SNN partitioning level can be implemented using Python, while the SNN execution level can use the C/C++ version of OpenMPI to implement parallel execution. In the embodiments of the present application, the SNN execution level is a packaged level; when using the framework to extract features of a brain-inspired application, a user only needs to call the interfaces of the SNN representation level and the SNN partitioning level.

Based on the above framework, given the basic constraints and the partitioning mapping scheme of the brain-inspired architecture, for any brain-inspired application, the features of the brain-inspired application before and after multi-core mapping can be analyzed.

It should be noted that the above-mentioned ONNX is an open neural network intermediate representation format, and OpenMPI is a message-passing-based parallel program development interface.

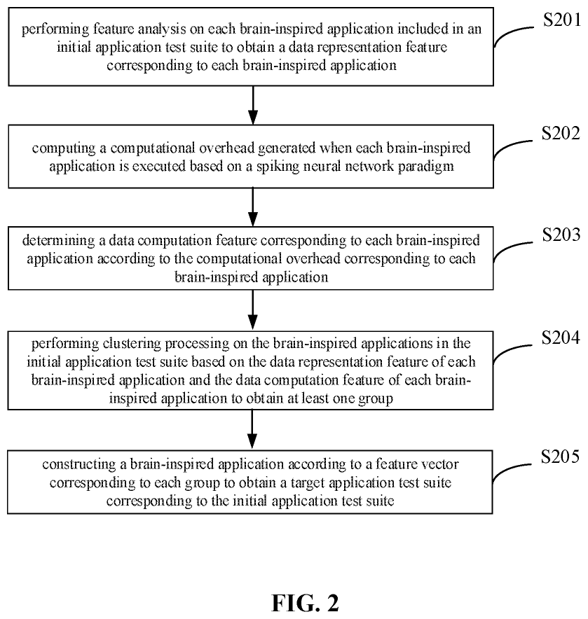

FIG. 2 shows a schematic flowchart of a method for determining a brain-inspired application test suite provided by an embodiment of the present application. As shown in FIG. 2, the method includes steps S201 to S205.

Step S201: performing feature analysis on each brain-inspired application included in an initial application test suite to obtain a data representation feature corresponding to each brain-inspired application.

In step S201, the initial application test suite is a set containing multiple brain-inspired applications, where the brain-inspired applications may include, but are not limited to, applications for processing multimodal perception information, applications for implementing language understanding and knowledge reasoning, applications for executing deep learning tasks, and applications for parallel computing. Some brain-inspired applications in the initial application test suite have the same or similar features. Using the solutions provided by the embodiments of the present application, the brain-inspired applications in the initial application test suite can be streamlined.

It should be noted that, in step S201, a brain-inspired application can be reduced to an SNN representation composed of several neurons and synapses. In the SNN, through the computation and communication of neurons and synapses, the overall functionality of a given brain-inspired application is implemented.

Additionally, in step S201, for a given SNN corresponding to a brain-inspired application, the behaviors of the brain-inspired application can be abstracted using the SDF model to obtain the main computation features of the brain-inspired application.

Specifically, the SNN representation abstracts the neurons and synapses in the brain-inspired application. To observe the execution of the brain-inspired application, the SDF model is used to describe the execution behavior of each neuron and synapse in the SNN representation. Each neuron and synapse is abstracted as a node in the SDF model. Data transmission between neurons and synapses is achieved through the transmission of spikes, which is represented as data reception and transmission on the SDF model. In this example, an SNN development framework (e.g., the PyNN framework) or a PyTorch-based deep SNN (i.e., D-SNN) development framework (e.g., the SpikingJelly framework, the Norse framework) can be used to describe a brain-inspired application. In this case, the organizational granularity of the brain-inspired application is neuron groups and synapse groups. For subsequent unified analysis, the neuron groups and synapse groups are split into several independent neurons and synapses to obtain an SDF representation, and based on this, the computation features of individuals and the whole are obtained. In the embodiments of the present application, in the process of obtaining computation features, the finest granularity (i.e., independent neuron and synapse individuals) is used for feature abstraction of the execution process of the brain-inspired application, to ensure that the granularity in the SNN representation level analysis is always consistent for different brain-inspired applications.

Through step S201, extracting the computation features of neurons and synapses in the SNN corresponding to each brain-inspired application yields the computation features corresponding to each brain-inspired application, including but not limited to the average spike firing rate of various types of neurons and synapses (including spike input sources), the spike firing interval of each neuron and synapse, the maximum transmission distance of spikes on the SNN, etc.

Step S202: computing a computational overhead generated when each brain-inspired application is executed based on a spiking neural network paradigm.

It should be noted that the computational overhead of a brain-inspired application is an important indicator for evaluating whether brain-inspired applications have orthogonality. Therefore, in the embodiments of the present application, it is necessary to determine the computational overhead corresponding to each brain-inspired application.

In step S202, the computational overhead corresponding to a brain-inspired application can be determined by aggregating the individual computational overheads of each neuron and synapse on the SNN during execution. Specifically, the computational overhead corresponding to a brain-inspired application is the sum of the computational overheads generated by each neuron and synapse on its corresponding SNN during computation. In addition, since a brain-inspired application is composed of multiple neurons and synapses, during execution, data transmission mediated by spikes exists between neurons and synapses. Because neurons and synapses on an SNN execute step by step in time steps, a spike can be numbered according to the firing time of the spike, the number of the neuron (or synapse) that fired the spike, and the number of the synapse (or neuron) that receives the spike. For example, neuron A receives spike D1 at time T1, performs computation at time T2, and transmits the generated output data as spike D2 to synapse B at time T3. Here, D2 is the input to synapse B, which performs computation in the next time step after receiving D2.

Considering that current brain-inspired chips or accelerators are developing towards multi-processor architectures, to better describe such parallel computing behavior, the present application introduces the BSP model as an abstraction of the brain-inspired multi-processor architecture. For the SDF model, it is partitioned into several partitions using a partitioning algorithm, where each partition contains a portion of the original neurons and synapses and retains the original connection relationships. Each partition is mapped to an execution unit in the BSP model. When there is spike transmission between neurons and synapses in two different partitions, it manifests as data transmission between the partitions, corresponding to communication between the processing units of the BSP model.

At this time, for each brain-inspired application, computational overheads such as the number of floating-point operations per neuron and synapse, the number of communications and the amount of communication data between and within execution units on the BSP model during application execution are counted.

Step S203: determining a data computation feature corresponding to each brain-inspired application according to the computational overhead corresponding to each brain-inspired application.

In step S203, based on the computation features and computational overheads corresponding to the brain-inspired applications, by filtering out the computation features that have the greatest impact on the computational overhead, the main features of brain-inspired computation (i.e., data computation features) are further determined. As an example, after determining the computation features and related data of a brain-inspired application, the existing computation features are standardized through principal component analysis, analyzed one by one, and the features that have the greatest impact on the computational overhead are retained. The relevant data during the execution of each brain-inspired application is mapped onto these features, thereby obtaining the feature vector representation corresponding to the application.

Step S204: performing clustering processing on the brain-inspired applications in the initial application test suite based on the data representation feature of each brain-inspired application and the data computation feature of each brain-inspired application to obtain at least one group.

In step S204, based on the above main features, clustering processing is performed on the brain-inspired applications in the initial application test suite, so that applications that are similar in terms of the main features are merged into the same group, resulting in several groups whose main features are pairwise orthogonal.

The data representation feature and the data computation feature of each brain-inspired application are features extracted at different levels (i.e., the SNN representation level and the SNN execution level in FIG. 1). After obtaining the features at different levels for each brain-inspired application, feature mapping can be performed on the features at different levels to obtain a mapping vector corresponding to each brain-inspired application. Then, clustering processing is performed on the brain-inspired applications in the initial application test suite based on the mapping vectors to obtain at least one group. Each group consists of at least one brain-inspired application, and the brain-inspired applications in each group have the same or similar features, i.e., the brain-inspired applications within each group exhibit similarity in terms of the above main features.

Step S205: constructing a brain-inspired application according to a feature vector corresponding to each group to obtain a target application test suite corresponding to the initial application test suite.

In step S205, the feature vector corresponding to each group is obtained by performing vector merging on the mapping vectors of the brain-inspired applications included in that group. Since the brain-inspired applications included in each group have the same or similar features, the spiking neural network constructed based on the feature vector corresponding to each group can represent any brain-inspired application in that group, i.e., the group is abstracted as an executable brain-inspired application. It is worth noting that because clustering is performed on the brain-inspired applications in the initial application test suite, the number of groups corresponding to the initial application test suite is not greater than the number of brain-inspired applications included in the initial application test suite. Therefore, the number of brain-inspired test applications constructed based on the feature vectors of each group is not greater than the number of brain-inspired applications included in the initial application test suite, i.e., the number of brain-inspired applications included in the target minimal test suite is less than or equal to the number of brain-inspired applications included in the initial application test suite, thereby achieving streamlining of the initial application test suite.

In addition, in the embodiments of the present application, brain-inspired applications within each group exhibit similarity in terms of the above main features, while brain-inspired applications from at least two groups exhibit significant dissimilarity in terms of features, i.e., brain-inspired applications between groups have orthogonality. The multiple brain-inspired applications in the target minimal test suite are constructed from the feature vectors corresponding to the groups. Therefore, the orthogonality among the multiple brain-inspired applications in the target minimal test suite is ensured.

Thus, the embodiments of the present application not only streamline the brain-inspired applications in the application test suite of the related art, but also ensure the orthogonality among the brain-inspired applications in the streamlined application test suite.

Based on the solutions defined in steps S201 to S205 above, it can be appreciated that the embodiments of the present application perform feature extraction on the brain-inspired application from multiple levels by extracting the data representation feature and the data computation feature of a brain-inspired application, thereby achieving quantitative analysis of the features of the brain-inspired application and providing a technical basis for streamlining an application test suite. In addition, in the embodiments of the present application, the brain-inspired applications in the target application test suite are constructed from the feature vectors of the groups, and the groups are obtained by performing clustering analysis on the brain-inspired applications in the application test suite based on the features of the brain-inspired applications, i.e., the brain-inspired applications included in a group have the same or similar features. Therefore, constructing brain-inspired applications based on the feature vectors of the groups obtained by clustering analysis can obtain a smaller number of brain-inspired applications, and these brain-inspired applications have orthogonality, thereby streamlining the application test suite. Using this streamlined application test suite to test the performance of a brain-inspired computing system can improve the testing efficiency of the brain-inspired computing system and enhance testing accuracy.

The solutions defined in steps S201 to S205 above are explained in detail below.

As shown in FIG. 1, before streamlining the brain-inspired applications in the initial application test suite, the data representation feature of each brain-inspired application included in the initial application test suite is first obtained at the SNN representation level, i.e., step S201 is performed.

Specifically, the conversion module deployed at the SNN representation level can split the neuron groups and synapse groups in each brain-inspired application to obtain multiple neurons and multiple synapses, where the multiple neurons are independent of each other, and the multiple synapses are independent of each other, i.e., obtaining several independent neurons and synapses corresponding to each brain-inspired application. Then, a merging operation is performed on the multiple synapses according to synaptic parameters of the multiple synapses, and a merging operation is performed on the multiple neurons according to neuronal parameters of the multiple neurons, to obtain data flow representation information corresponding to each brain-inspired application. That is, synapses having the same parameters and belonging to the same neuron are merged to obtain the minimal structural representation corresponding to each brain-inspired application. Finally, feature analysis is performed on the data flow representation information to obtain the data representation feature corresponding to each brain-inspired application.

It should be noted that the above-mentioned multiple neurons and synapses are independent of each other.

As an example, before obtaining the data representation feature of a brain-inspired application, each brain-inspired application needs to be uniformly converted into an ONNX representation format at the application level, thereby achieving unification of data formats. For neuroscience-oriented brain-inspired applications, the interfaces provided by the PyNN framework can be used to describe the brain-inspired application, and a custom export module can be used to obtain the ONNX representation of the brain-inspired application. For D-SNN applications, development frameworks based on PyTorch such as SpikingJelly and Norse can be used to describe the brain-inspired application, and the ONNX module of PyTorch can be used to export the corresponding ONNX representation.

Further, after achieving unification of the representation formats of the brain-inspired applications, the conversion module parses the ONNX representation corresponding to each brain-inspired application to obtain the neuron groups and synapse groups in the ONNX format, then splits the neuron groups and synapse groups into several independent neurons and synapses, and then merges synapses with the same parameters, thereby obtaining the minimal SDF representation corresponding to the brain-inspired application.

Furthermore, after obtaining the SDF representation of each brain-inspired application, the computation of each neuron and synapse during the execution of the brain-inspired application and the data transmission mediated by spikes are analyzed to obtain the data representation feature corresponding to each brain-inspired application. The data representation features include static features and dynamic features. The static features may include, but are not limited to, the topology of the SNN representation corresponding to the brain-inspired application, the number of floating-point operations per time step for various types of neurons and synapses in the SNN, etc. The dynamic features may include, but are not limited to, the spike firing status of various neurons and synapses during execution (e.g., average spike firing rate, distribution of spike firing intervals), and runtime-related features of the brain-inspired application before partitioning.

From the above, through the above step S201, at the SNN representation level, using individual neurons and synapses as the organizational granularity, the extraction of the data representation feature of the brain-inspired application is achieved.

As shown in FIG. 1, after obtaining the data representation feature of the brain-inspired application, the computational overhead generated by each brain-inspired application when executed in parallel after being partitioned and mapped onto multiple processing units is extracted at the SNN execution level. Given that mainstream brain-inspired chips in the related art are mostly multi-processor high-performance architectures, to analyze the behavior of each brain-inspired application when partitioned and executed in parallel on multiple processors, a partitioning module is introduced in the embodiments of the present application to partition the SNN.

Specifically, based on a partitioning algorithm, the multiple neurons and multiple synapses corresponding to each brain-inspired application are partitioned to obtain multiple partitions. After the multiple neurons and multiple synapses corresponding to each brain-inspired application are partitioned based on the partitioning algorithm to obtain the multiple partitions, partition information of each partition is collected to obtain a data partition feature corresponding to each brain-inspired application.

It should be noted that connection relationships exist between the neurons and synapses included in each partition. The above-mentioned partition information at least includes connection information between neurons and synapses included in each partition, and connection relationships between neurons and synapses in each partition and neurons and synapses in other partitions.

In addition, it should also be noted that as the brain-inspired architecture gradually evolves towards a high-performance multi-processor architecture interconnected by Network-on-Chip (NoC), to analyze the runtime characteristics of a brain-inspired application on an actual architecture, it is also necessary to consider the multi-processor mapping of the brain-inspired application. That is, after abstracting the brain-inspired architecture into a BSP model, the SNN representation corresponding to the brain-inspired application is partitioned, each partition is mapped onto an execution unit corresponding to the BSP model for parallel execution, and based on the execution results, information about the parallel execution of the brain-inspired application on multiple processing units is extracted.

SDF partitioning is an application of graph partitioning, and graph partitioning is an NP (Non-deterministic Polynomial) complete problem, i.e., there is no optimal solution. To implement graph partitioning efficiently, those skilled in the art have successively proposed various efficient algorithms. Before performing subsequent analysis, it is necessary to determine the partitioning algorithm and scheduling strategy for partitioning the brain-inspired application. This analysis can be performed with the help of the partitioning module. Furthermore, after fixing the brain-inspired application to be used, the impact of different graph partitioning algorithms on the computational overhead can also be evaluated, thereby assessing the performance of the partitioning algorithm on the application.

The partitioning of the brain-inspired application is implemented at the SNN partitioning level shown in FIG. 1, where a partitioning module is deployed. In the partitioning module, the SDF can be abstracted into a simple graph that retains only the connection relationships between neurons and synapses. This process can be implemented through an interface based on the graph analysis tool NetworkX. The output of the NetworkX interface is an unweighted graph. The user can customize the graph partitioning algorithm based on NetworkX. After partitioning the above unweighted graph, the partitioning module organizes the neurons and synapses into several partitions according to the groups, and can adjust them using a user-defined scheduling strategy.

As an example, a partitioning algorithm and a scheduling strategy that match the brain-inspired application can be selected from multiple partitioning algorithms and multiple scheduling strategies, and the selected partitioning algorithm and scheduling strategy can be used to partition the brain-inspired application. The above partitioning algorithm and scheduling strategy can be selected by the user. In this scenario, it is necessary to ensure that the partitioning algorithm and scheduling strategy selected by the user are compatible with NetworkX to reduce system development difficulty. The above partitioning algorithm can be an open-source graph partitioning algorithm based on the NetworkX backend (e.g., the METIS and Louvain graph partitioning algorithms).

After determining the partitioning algorithm and related scheduling strategy, it is also necessary to determine the partition capacity corresponding to each partition. The partition capacity is used to characterize the maximum number of neurons and synapses a partition can accommodate. For the same brain-inspired application, the partition capacities of its corresponding multiple partitions may be the same or different.

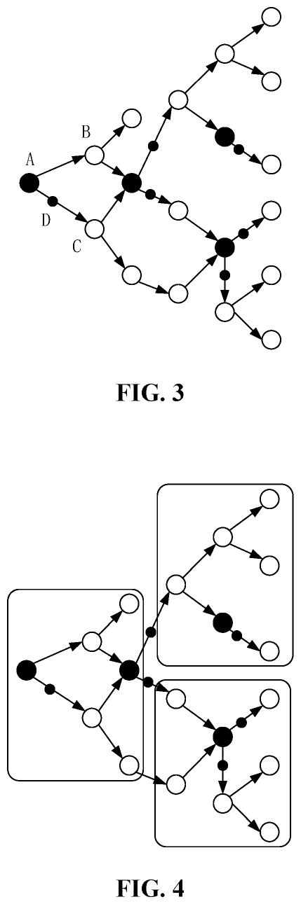

Further, after determining the partitioning algorithm corresponding to each brain-inspired application and the partition capacity corresponding to each partition, the partitioning module can perform a partitioned representation of the data representation feature corresponding to the brain-inspired application, thereby obtaining multiple partitions. For example, the partitioning module can partition the brain-inspired application shown in FIG. 3 to obtain the multiple partitions shown in FIG. 4. At the same time, the partitioning module can also collect partition information corresponding to each partition to obtain the data partition feature corresponding to each brain-inspired application.

It should be noted that each circle in FIG. 3 represents a neuron or a synapse. For ease of representation, we refer to such a single neuron or synapse as a spike operator, and the arrows indicate that data transmission is required between two spike operators. For example, in FIG. 3, when spike operator A executes, it needs to transmit data to spike operators B and C. Node D indicates that spike operator A is transmitting data to spike operator C.

In addition, the data partition feature corresponding to each brain-inspired application may include, but is not limited to, the number of partitions, the number of various types of neurons and synapses included in each partition, the number of cross-core instances corresponding to each partition and the number of partitions requiring cross-processing unit data transmission, the number of subsequent neurons and synapses of each neuron and synapse in each partition on the same computing unit and on other computing units. A subsequent neuron or synapse of a current neuron or synapse receives the spike transmitted by the current neuron or synapse. For example, in FIG. 3, spike operator C is a successor of spike operator A.

Furthermore, after determining the parameters corresponding to the brain-inspired application and the brain-inspired architecture, the computational cost corresponding to each brain-inspired application under different partitioning algorithms and/or scheduling strategies can be evaluated in conjunction with the SNN execution level. Then, based on this computational cost, the partitioning algorithms and/or scheduling strategies can be adjusted or optimized to enhance the applicability of the architecture shown in FIG. 1.

As shown in FIG. 1, after the brain-inspired application is partitioned at the SNN partitioning level, the representation module at the SNN execution level is used to calculate the computational overhead generated by executing each brain-inspired application based on the spiking neural network paradigm.

Specifically, the representation module deployed at the SNN execution level calculates the computational overhead generated by performing computation with the neurons and synapses included in each partition to obtain a first computational overhead corresponding to each partition, and calculates the transmission overhead for data transmission between the multiple partitions to obtain a second computational overhead. Finally, based on the first computational overhead corresponding to each partition and the second computational overhead, the computational overhead corresponding to each brain-inspired application is determined.

It should be noted that, as one of the mainstream parallel models, the BSP model, similar to the SDF model, can quantify the computational overhead of parallel algorithms that execute multiple partitions in parallel based on a synchronization mechanism.

As an example, a multi-core simulation environment based on the Bulk framework (a BSP development framework) is deployed at the SNN execution level. Multiple execution units are deployed in the simulation environment, each execution unit being used to execute the neurons and synapses included in one partition. As shown in the schematic diagram corresponding to the SNN execution level in FIG. 5, each execution unit corresponds to one partition shown in FIG. 4, and each execution unit consists of a computing unit, a storage unit, a receiving queue, and a sending queue. In FIG. 5, the computing unit is used to execute neurons and synapses to process data to be processed; the storage unit is used to store the neurons and synapses included in the corresponding partition; the receiving queue is used to temporarily store data to be processed, which may be data transmitted from other execution units to the current execution unit, or data obtained by executing neurons and synapses in the current execution unit; the sending queue is used to temporarily store the results obtained after the computing unit processes the data to be processed using the neurons and synapses.

In the embodiments of the present application, the representation module at the SNN execution level can export the multiple partitions obtained through partitioning at the SNN partitioning level into a JSON format file. Then, during the initialization of the SNN execution level, the format-converted partitions are read and loaded into the simulation environment deployed at the SNN execution level, and then the corresponding neurons and synapses are executed in the execution units in the simulation environment.

It should be noted that since the JSON format is compatible with various hardware devices in the field of brain-inspired computing, converting partitions into the JSON format allows the SNN partitioning level to directly process the partitions without relying on the SNN partitioning level, thereby achieving decoupling of the SNN partitioning level and the SNN execution level.

In addition, the computational overhead corresponding to a brain-inspired application consists of the overhead for performing computation on the data to be processed (i.e., the first computational overhead) and the transmission overhead for data transmission between partitions (i.e., the second computational overhead). For the first computational overhead, before execution, normalization processing is performed on the data to be processed corresponding to each partition to obtain a normalization processing result. The normalization processing result includes at least the neurons and synapses that need to participate in the computation. Then, based on the normalization processing result, the neurons and synapses to be used, i.e., the neurons and synapses to be involved in the computation, are determined. Finally, the computational overhead generated by processing the data to be processed corresponding to each partition using these neurons and synapses to be used is counted to obtain the first computational overhead.

As an example, in the simulation environment for SNN execution, each execution unit is used to execute the neurons and synapses in each partition. In each execution unit, before performing the computation of the neurons and synapses, i.e., before using the neurons and synapses to process the received spikes, the spikes to be processed in the receiving queue are normalized, i.e., spikes targeting the same target neuron or synapse are normalized, to obtain a normalization processing result. Based on the normalization processing result, the neurons and synapses that need to participate in the computation, i.e., the neurons and synapses to be used, are determined. Then, the computing unit loads the neurons and synapses to be used from the storage unit, and these neurons and synapses perform update operations after receiving the normalized spikes. After the computation is completed, if it is necessary to generate spike transmission and the spike needs to be transmitted to other execution units, where neurons and synapses in the other execution units will further process the spike, then this spike transmission is determined to be a cross-core transmission. At this time, the computing unit places the processing result as a spike into the sending queue, waiting for all processing units to complete processing. If, after the computation, it is determined that a spike is generated and the spike only needs to be transmitted to other neurons or synapses on the same execution unit without being transmitted to other execution units, then this data transmission is determined to be an intra-core transmission. At this time, the computing unit places the spike into the receiving queue of the processing unit to which it belongs, so that the computing unit continues to load the neuron or synapse responsible for processing the spike and continues processing the spike. The above process is repeated until there are no other spikes in the receiving queue of the current execution unit. At this time, all execution units enter a synchronization phase together. In the synchronization phase, each processing unit sends the spikes in its sending queue to the receiving queues of the execution units corresponding to each spike for subsequent processing, until all spikes from all processing units have been sent, i.e., the sending queues of all processing units are empty, then they synchronously enter the computation phase. The above process is repeated to complete the execution of the application.

It should be noted that, through the above process, based on the hierarchical BSP paradigm, the SNN execution level can analyze the computational overhead corresponding to each execution unit at each time step, and then calculate the sum of the computational overheads corresponding to each execution unit to obtain the computational overhead corresponding to the brain-inspired application. This computational overhead can reflect the computational complexity of the brain-inspired application on the BSP.

Further, after obtaining the computational overhead of the brain-inspired application, the data computation feature corresponding to the brain-inspired application can be determined based on the computational overhead of the brain-inspired application, i.e., step S203.

Furthermore, after obtaining the data representation feature, partition feature, and data computation feature corresponding to each brain-inspired application, similarity analysis can be performed on the brain-inspired applications in the initial application test suite to identify brain-inspired applications that exhibit similarity, i.e., step S204 is performed.

Specifically, first, a key feature is extracted from the application features of each brain-inspired application, and multiple regression processing is performed on the key features of multiple brain-inspired applications to obtain a mapping vector corresponding to each brain-inspired application. Finally, hierarchical clustering analysis is performed on the mapping vectors corresponding to multiple brain-inspired applications, i.e., several applications that are similar in terms of features are grouped into the same group, ensuring that at least one group is obtained, thereby achieving similarity analysis of the initial application test suite.

It should be noted that the above application features at least include: the data representation feature, the data partition feature, and the data computation feature. The above key feature is a feature among each application feature that has a significant impact on the output result of the brain-inspired application. For each brain-inspired application, its corresponding key feature at least includes a first key feature, a second key feature, and a third key feature. The first key feature, the second key feature, and the third key feature correspond to the data representation feature, the data partition feature, and the data computation feature, respectively.

In the process of extracting the key feature from the application features of each brain-inspired application, the first key feature is extracted from the data representation feature of a first brain-inspired application according to a degree of influence of the data representation feature of the first brain-inspired application on an output result of the first brain-inspired application, where the first brain-inspired application is any brain-inspired application in the initial application test suite. The second key feature is extracted from the data partition feature of the first brain-inspired application according to a degree of influence of the data partition feature of the first brain-inspired application on the output result of the first brain-inspired application. The third key feature is extracted from the data computation feature of the first brain-inspired application according to a degree of influence of the data computation feature of the first brain-inspired application on the output result of the first brain-inspired application.

It should be noted that extracting the key features from the application features of a brain-inspired application can reduce the feature space dimension at each level, thereby reducing the complexity of computation feature analysis of the application test suite.

After obtaining the key features of each brain-inspired application, multiple regression processing can be performed on the key features of multiple brain-inspired applications to obtain a mapping vector corresponding to each brain-inspired application, i.e., establishing a feature mapping from the SNN representation level-SNN partitioning level-SNN execution level.

Specifically, multiple regression processing is performed on the first key feature, the second key feature, and the third key feature to obtain a mapping relationship among the first key feature, the second key feature, and the third key feature. Then, vector construction is performed on the first key feature, the second key feature, and the third key feature based on the mapping relationship to obtain the mapping vector corresponding to each brain-inspired application. That is, for a brain-inspired application, a mapping relationship among the first key feature, the second key feature, and the third key feature is established, so that each brain-inspired application can be represented by a mapping vector.

Further, after obtaining the mapping vector corresponding to each brain-inspired application, hierarchical clustering analysis can be performed on multiple brain-inspired applications based on the mapping vectors corresponding to multiple brain-inspired applications.

Specifically, first, a vector distance between mapping vectors of any two brain-inspired applications in the initial application test suite is calculated, and clustering analysis is performed on multiple brain-inspired applications in the initial application test suite according to the vector distance, so that applications with close distances are preliminarily grouped together, resulting in at least one initial group. Next, vector merging is performed on the mapping vectors of the brain-inspired applications included in each initial group to obtain a feature vector corresponding to each initial group. When the number of the at least one initial group is multiple, vector distances between feature vectors corresponding to any two initial groups among the multiple initial groups are calculated. Then, clustering is performed on the multiple initial groups based on the vector distances of any two initial groups to obtain the at least one group. Through hierarchical clustering, based on the feature similarity of the applications, the applications are grouped, ensuring that the computation features of each final group exhibit orthogonality.

As an example, one brain-inspired application (hereinafter referred to as the target brain-inspired application) is arbitrarily selected from the initial application test suite, and the vector distances between the mapping vectors of other brain-inspired applications and the mapping vector of the target brain-inspired application are calculated. Brain-inspired applications whose vector distances satisfy a preset condition are merged to obtain an initial group. For example, brain-inspired applications with a vector distance less than a preset vector distance are merged to obtain the initial group corresponding to the target brain-inspired application. Then, the above process is repeated for brain-inspired applications not yet merged into an initial group until all brain-inspired applications have a corresponding initial group.

To ensure that the brain-inspired applications in the streamlined application test suite all have orthogonality, after obtaining multiple initial groups, further clustering is performed on the multiple initial groups. This clustering process is similar to the clustering process performed on the brain-inspired applications. First, vector merging is performed on the mapping vectors of the brain-inspired applications within each initial group to obtain a feature vector corresponding to each initial group. Then, vector distances between any two initial groups are calculated, and the initial groups are merged based on the vector distances between any two initial groups to obtain at least one group.

It should be noted that the above vector distance is used to characterize the similarity between two vectors, and this similarity can reflect the degree of orthogonality between two brain-inspired applications or two initial groups.

Furthermore, after obtaining the at least one group corresponding to the initial application test suite, a brain-inspired application corresponding to each group can be constructed, and then a target application test suite is formed based on the constructed brain-inspired applications, so that the brain-inspired applications included in the target application test suite have orthogonality.

Based on the above content, it can be appreciated that the solutions provided by the embodiments of the present application can achieve feature extraction for brain-inspired applications, providing a reference for the design of a brain-inspired test suite. Given a brain-inspired test suite, using the solutions provided by the embodiments of the present application, a minimal application test suite can be obtained, providing a design basis for a benchmark test suite for brain-inspired computing. In addition, the solutions provided by the embodiments of the present application can also quantitatively analyze the computation features of brain-inspired applications based on a decoupled analysis framework. By adjusting the inputs at each level, the evaluation of partitioning algorithms and scheduling strategies for brain-inspired applications can be achieved, and the performance testing of a brain-inspired computing system can also be realized.

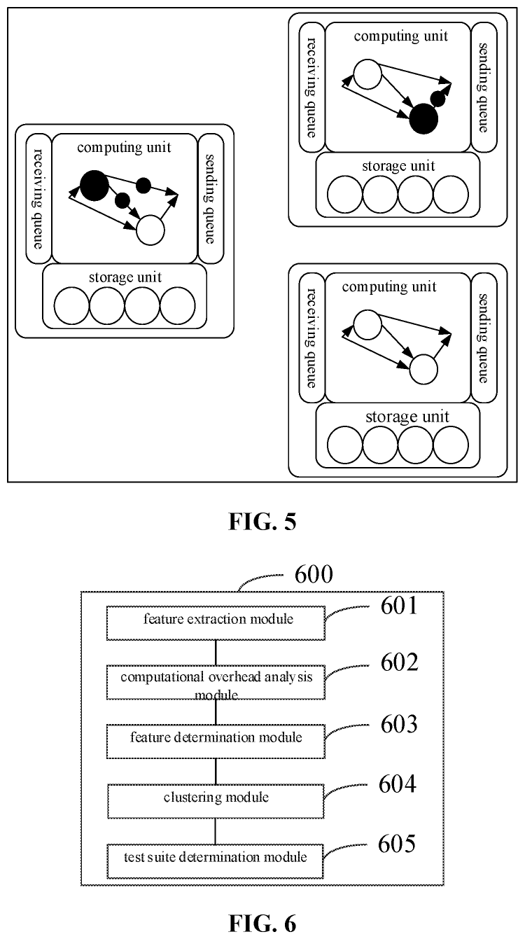

The embodiments of the present application also provide an apparatus for determining a brain-inspired application test suite. As shown in FIG. 6, the apparatus 600 includes: a feature extraction module 601, a computational overhead analysis module 602, a feature determination module 603, a clustering module 604, and a test suite determination module 605.

The feature extraction module 601 is configured to perform feature analysis on each brain-inspired application included in an initial application test suite to obtain a data representation feature corresponding to each brain-inspired application.

The computational overhead analysis module 602 is configured to compute a computational overhead generated when each brain-inspired application is executed based on a spiking neural network paradigm.

The feature determination module 603 is configured to determine a data computation feature corresponding to each brain-inspired application according to the computational overhead corresponding to each brain-inspired application.

The clustering module 604 is configured to perform clustering processing on the brain-inspired applications in the initial application test suite based on the data representation feature of each brain-inspired application and the data computation feature of each brain-inspired application to obtain at least one group.

The test suite determination module 605 is configured to construct a brain-inspired application according to a feature vector corresponding to each group to obtain a target application test suite corresponding to the initial application test suite, wherein multiple brain-inspired applications in the target application test suite have orthogonality.

In one example, the feature extraction module is specifically configured to split a neuron group and a synapse group in each brain-inspired application to obtain a plurality of neurons and a plurality of synapses, wherein the plurality of neurons are independent of each other, and the plurality of synapses are independent of each other; perform a merging operation on the plurality of synapses according to synaptic parameters of the plurality of synapses, and perform a merging operation on the plurality of neurons according to neuronal parameters of the plurality of neurons, to obtain data flow representation information corresponding to each brain-inspired application; and perform feature analysis on the data flow representation information to obtain the data representation feature corresponding to each brain-inspired application.

In one example, the computational overhead analysis module includes: a partitioning module, a first overhead calculation module, a second overhead calculation module, and a third overhead calculation module. The partitioning module is configured to perform partitioning processing on the plurality of neurons and the plurality of synapses corresponding to each brain-inspired application based on a partitioning algorithm to obtain a plurality of partitions, wherein at least a connection relationship exists between spike operators included in each partition. The first overhead calculation module is configured to compute a computational overhead generated by computing with neurons and synapses included in each partition to obtain a first computational overhead corresponding to each partition. The second overhead calculation module is configured to compute a transmission overhead for data transmission between the plurality of partitions to obtain a second computational overhead. The third overhead calculation module is configured to determine the computational overhead corresponding to each brain-inspired application based on the first computational overhead corresponding to each partition and the second computational overhead.

In one example, the apparatus for determining a brain-inspired application test suite further includes: a feature statistics module configured to collect partition information of each partition to obtain a data partition feature corresponding to each brain-inspired application, wherein the partition information at least comprises connection information between neurons and synapses included in each partition, and connection relationships between neurons and synapses in each partition and neurons and synapses in other partitions.

In one example, the first overhead calculation module is specifically configured to perform normalization processing on to-be-processed data corresponding to each partition to obtain a normalization processing result; determine neurons and synapses to be used according to the normalization processing result; and count a computational cost generated by processing the to-be-processed data corresponding to each partition using the neurons and synapses to be used, to obtain the first computational overhead.

In one example, the clustering module includes: a key feature extraction module, a regression processing module, and a hierarchical clustering module. The key feature extraction module is configured to extract a key feature from application features of each brain-inspired application, wherein the application features at least comprise: the data representation feature, the data partition feature, and the data computation feature. The regression processing module is configured to perform multiple regression processing on the key features of multiple brain-inspired applications to obtain a mapping vector corresponding to each brain-inspired application. The hierarchical clustering module is configured to perform hierarchical clustering analysis on the mapping vectors corresponding to multiple brain-inspired applications to obtain the at least one group.

In one example, the key feature of each brain-inspired application at least comprises a first key feature, a second key feature, and a third key feature, wherein the key feature extraction module is specifically configured to extract the first key feature from a data representation feature of a first brain-inspired application according to a degree of influence of the data representation feature of the first brain-inspired application on an output result of the first brain-inspired application, wherein the first brain-inspired application is any brain-inspired application in the initial application test suite; extract the second key feature from a data partition feature of the first brain-inspired application according to a degree of influence of the data partition feature of the first brain-inspired application on the output result of the first brain-inspired application; and extract the third key feature from a data computation feature of the first brain-inspired application according to a degree of influence of the data computation feature of the first brain-inspired application on the output result of the first brain-inspired application.

In one example, the regression processing module is specifically configured to perform multiple regression processing on the first key feature, the second key feature, and the third key feature to obtain a mapping relationship among the first key feature, the second key feature, and the third key feature; and perform vector construction on the first key feature, the second key feature, and the third key feature based on the mapping relationship to obtain the mapping vector corresponding to each brain-inspired application.

In one example, the hierarchical clustering module is specifically configured to calculate a vector distance between mapping vectors of any two brain-inspired applications in the initial application test suite; perform clustering analysis on multiple brain-inspired applications in the initial application test suite according to the vector distance to obtain at least one initial group; perform vector merging on mapping vectors of brain-inspired applications included in each initial group to obtain a feature vector corresponding to each initial group; when the number of the at least one initial group is multiple, calculate a vector distance between feature vectors corresponding to any two initial groups among the multiple initial groups; and perform clustering on the multiple initial groups based on the vector distance of the any two initial groups to obtain the at least one group.

The apparatus for determining a brain-inspired application test suite provided by the embodiments of the present application can implement the various processes implemented by the foregoing method embodiments. To avoid repetition, details are not described herein again.

A person skilled in the art can clearly understand that, for the convenience and brevity of description, only the division of the above functional units and modules is used as an example. In practical applications, the above functions can be allocated to different functional units and modules as needed, i.e., the internal structure of the apparatus is divided into different functional units or modules to complete all or part of the functions described above. The functional units and modules in the embodiments may be integrated into one processing unit, or each unit may exist physically separately, or two or more units may be integrated into one unit. The above integrated units may be implemented in the form of hardware or in the form of software functional units. In addition, the specific names of the functional units and modules are only for the convenience of distinguishing each other and are not used to limit the protection scope of the present application. For the specific working processes of the units and modules in the above system, reference may be made to the corresponding processes in the foregoing method embodiments, and details are not described herein again.

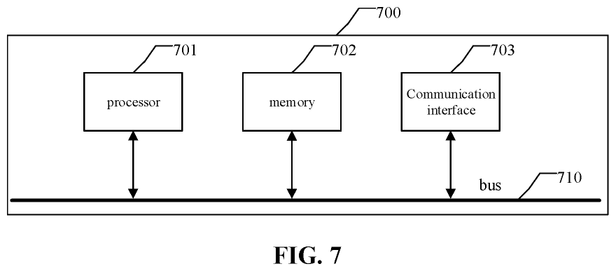

FIG. 7 shows a schematic structural diagram of hardware of an electronic device according to an embodiment of the present application.

The electronic device 700 may include a processor 701 and a memory 702 storing computer program instructions.

Specifically, the processor 701 may include a central processing unit (CPU), or an application specific integrated circuit (ASIC), or one or more integrated circuits configured to implement the embodiments of the present application.

The memory 702 may include a mass storage for data or instructions. By way of example and not limitation, the memory 702 may include a hard disk drive (HDD), a floppy disk drive, a flash memory, an optical disk, a magneto-optical disk, a magnetic tape, or a universal serial bus (USB) drive, or a combination of two or more thereof. Where appropriate, the memory 702 may include a removable or non-removable (or fixed) medium. Where appropriate, the memory 702 may be internal or external to an integrated gateway disaster recovery device. In a specific embodiment, the memory 702 is a non-volatile solid-state memory.

The memory may include a read-only memory (ROM), a random access memory (RAM), a magnetic disk storage media device, an optical storage media device, a flash memory device, an electrical, optical, or other physical/tangible memory storage device. Therefore, generally, the memory includes one or more tangible (non-transitory) computer-readable storage media (e.g., memory devices) encoded with software including computer-executable instructions, and when the software is executed (e.g., by one or more processors), it is operable to perform the operations described with reference to the methods according to an aspect of the present disclosure.

The processor 701 implements the method for determining a brain-inspired application test suite according to any of the above embodiments by reading and executing the computer program instructions stored in the memory 702.

In one example, the electronic device may further include a communication interface 703 and a bus 710. As shown in FIG. 7, the processor 701, the memory 702, and the communication interface 703 are connected and communicate with each other via the bus 710.

The communication interface 703 is mainly configured to implement communication among various modules, devices, units, and/or apparatuses in the embodiments of the present application.

The bus 710 includes hardware, software, or both, coupling the components of the electronic device to each other. By way of example and not limitation, the bus may include an Accelerated Graphics Port (AGP) or other graphics bus, an Enhanced Industry Standard Architecture (EISA) bus, a Front Side Bus (FSB), a Hyper Transport (HT) interconnect, an Industry Standard Architecture (ISA) bus, an InfiniBand interconnect, a Low Pin Count (LPC) bus, a memory bus, a Micro Channel Architecture (MCA) bus, a Peripheral Component Interconnect (PCI) bus, a PCI-Express (PCI-X) bus, a Serial Advanced Technology Attachment (SATA) bus, a Video Electronics Standards Association Local (VLB) bus, or other suitable bus, or a combination of two or more thereof. Where appropriate, the bus 710 may include one or more buses. Although the embodiments of the present application describe and illustrate a specific bus, the present application contemplates any suitable bus or interconnect.

In addition, in combination with the method for determining a brain-inspired application test suite in the above embodiments, an embodiment of the present application may provide a computer-readable storage medium to implement the method. The computer-readable storage medium has computer program instructions stored thereon; the computer program instructions, when executed by a processor, implement the method for determining a brain-inspired application test suite according to any of the above embodiments.

In addition, in combination with the method for determining a brain-inspired application test suite in the above embodiments, an embodiment of the present application may provide a computer program product to implement the method. When instructions in the computer program product are executed by a processor of an electronic device, the electronic device is caused to execute the method for determining a brain-inspired application test suite according to any of the above embodiments.

It should be clarified that the present application is not limited to the specific configurations and processes described above and illustrated in the drawings. For brevity, a detailed description of known methods is omitted here. In the above embodiments, several specific steps are described and illustrated as examples. However, the process of the method of the present application is not limited to the described and illustrated specific steps, and a person skilled in the art can make various changes, modifications, and additions, or change the order of steps, after understanding the spirit of the present application.

The functional modules shown in the above structural block diagrams can be implemented as hardware, software, firmware, or a combination thereof. When implemented in hardware, it can be, for example, an electronic circuit, an application specific integrated circuit (ASIC), appropriate firmware, a plug-in, a function card, etc. When implemented in software, the elements of the present application are programs or code segments that perform the required tasks. The programs or code segments can be stored in a machine-readable medium or transmitted on a transmission medium or communication link via a data signal carried in a carrier wave. A “machine-readable medium” may include any medium that can store or transmit information. Examples of machine-readable media include electronic circuits, semiconductor memory devices, ROM, flash memory, erasable ROM (EROM), floppy disks, CD-ROMs, optical disks, hard disks, fiber optic media, radio frequency (RF) links, and the like. The code segments can be downloaded via a computer network such as the Internet, an intranet, etc.

It should also be noted that the exemplary embodiments mentioned in the present application describe some methods or systems based on a series of steps or devices. However, the present application is not limited to the order of the steps, i.e., the steps may be performed in the order mentioned in the embodiments, or in an order different from that in the embodiments, or several steps may be performed simultaneously.

The above description, with reference to the flowcharts and/or block diagrams of the method, apparatus (system), and computer program product according to the embodiments of the present disclosure, describes various aspects of the present disclosure. It should be understood that each block in the flowcharts and/or block diagrams, and combinations of blocks in the flowcharts and/or block diagrams, can be implemented by computer program instructions. These computer program instructions may be provided to a processor of a general-purpose computer, special-purpose computer, or other programmable data processing apparatus to produce a machine, such that the instructions executed by the processor of the computer or other programmable data processing apparatus enable the implementation of the functions/acts specified in one or more blocks of the flowcharts and/or block diagrams. Such a processor may be, but is not limited to, a general-purpose processor, a special-purpose processor, an application-specific processor, or a field programmable logic circuit. It should also be understood that each block in the block diagrams and/or flowcharts, and combinations of blocks in the block diagrams and/or flowcharts, can also be implemented by special-purpose hardware that performs the specified functions or actions, or by a combination of special-purpose hardware and computer instructions.

The above description is only specific implementation manners of the present application. A person skilled in the art can clearly understand that, for the convenience and brevity of description, the specific working processes of the above-described systems, modules, and units can refer to the corresponding processes in the foregoing method embodiments, and details are not described herein again. It should be understood that the protection scope of the present application is not limited thereto, and any person skilled in the art can easily conceive of various equivalent modifications or replacements within the technical scope disclosed in the present application, and these modifications or replacements should all fall within the protection scope of the present application.

What is claimed is:

1. A method for determining a brain-inspired application test suite, comprising:
performing feature analysis on each brain-inspired application included in an initial application test suite to obtain a data representation feature corresponding to each brain-inspired application;
computing a computational overhead generated when each brain-inspired application is executed based on a spiking neural network paradigm;
determining a data computation feature corresponding to each brain-inspired application according to the computational overhead corresponding to each brain-inspired application;
performing clustering processing on the brain-inspired applications in the initial application test suite based on the data representation feature of each brain-inspired application and the data computation feature of each brain-inspired application to obtain at least one group; and
constructing a brain-inspired application according to a feature vector corresponding to each group to obtain a target application test suite corresponding to the initial application test suite, wherein multiple brain-inspired applications in the target application test suite have orthogonality.

2. The method according to claim 1, wherein performing feature analysis on each brain-inspired application included in the initial application test suite to obtain the data representation feature corresponding to each brain-inspired application comprises:
splitting a neuron group and a synapse group in each brain-inspired application to obtain a plurality of neurons and a plurality of synapses, wherein the plurality of neurons are independent of each other, and the plurality of synapses are independent of each other;
performing a merging operation on the plurality of synapses according to synaptic parameters of the plurality of synapses, and performing a merging operation on the plurality of neurons according to neuronal parameters of the plurality of neurons, to obtain data flow representation information corresponding to each brain-inspired application; and
performing feature analysis on the data flow representation information to obtain the data representation feature corresponding to each brain-inspired application.

3. The method according to claim 2, wherein computing the computational overhead generated when each brain-inspired application is executed based on the spiking neural network paradigm comprises:
performing partitioning processing on the plurality of neurons and the plurality of synapses corresponding to each brain-inspired application based on a partitioning algorithm to obtain a plurality of partitions, wherein at least a connection relationship exists between pulse operators included in each partition;
computing a computational overhead generated by computing with neurons and synapses included in each partition to obtain a first computational overhead corresponding to each partition;
computing a transmission overhead for data transmission between the plurality of partitions to obtain a second computational overhead; and
determining the computational overhead corresponding to each brain-inspired application based on the first computational overhead corresponding to each partition and the second computational overhead.

4. The method according to claim 3, wherein after performing partitioning processing on the plurality of neurons and the plurality of synapses corresponding to each brain-inspired application based on the partitioning algorithm to obtain the plurality of partitions, the method further comprises:
extracting partition information of each partition to obtain a data partition feature corresponding to each brain-inspired application, wherein the partition information at least comprises connection information between neurons and synapses included in each partition, and connection relationships between neurons and synapses in each partition and neurons and synapses in other partitions.

5. The method according to claim 3, wherein computing the computational overhead generated by computing with neurons and synapses included in each partition to obtain the first computational overhead corresponding to each partition comprises:
performing normalization processing on to-be-processed data corresponding to each partition to obtain a normalization processing result;
determining neurons and synapses to be used according to the normalization processing result; and
counting a computational cost generated by processing the to-be-processed data corresponding to each partition using the neurons and synapses to be used, to obtain the first computational overhead.

6. The method according to claim 4, wherein performing clustering processing on the brain-inspired applications in the initial application test suite based on the data representation feature of each brain-inspired application and the data computation feature of each brain-inspired application to obtain at least one group comprises:
extracting a key feature from application features of each brain-inspired application, wherein the application features at least comprise: the data representation feature, the data partition feature, and the data computation feature;
performing multiple regression processing on the key features of multiple brain-inspired applications to obtain a mapping vector corresponding to each brain-inspired application; and
performing hierarchical clustering analysis on the mapping vectors corresponding to the multiple brain-inspired applications to obtain the at least one group.

7. The method according to claim 6, wherein the key feature of each brain-inspired application at least comprises a first key feature, a second key feature, and a third key feature, and wherein extracting the key feature from the application features of each brain-inspired application comprises:
extracting the first key feature from a data representation feature of a first brain-inspired application according to a degree of influence of the data representation feature of the first brain-inspired application on an output result of the first brain-inspired application, wherein the first brain-inspired application is any brain-inspired application in the initial application test suite;
extracting the second key feature from a data partition feature of the first brain-inspired application according to a degree of influence of the data partition feature of the first brain-inspired application on the output result of the first brain-inspired application; and
extracting the third key feature from a data computation feature of the first brain-inspired application according to a degree of influence of the data computation feature of the first brain-inspired application on the output result of the first brain-inspired application.

8. The method according to claim 7, wherein performing multiple regression processing on the key features of the multiple brain-inspired applications to obtain the mapping vector corresponding to each brain-inspired application comprises:
performing multiple regression processing on the first key feature, the second key feature, and the third key feature to obtain a mapping relationship among the first key feature, the second key feature, and the third key feature; and
performing vector construction on the first key feature, the second key feature, and the third key feature based on the mapping relationship to obtain the mapping vector corresponding to each brain-inspired application.

9. The method according to claim 6, wherein performing hierarchical clustering analysis on the mapping vectors corresponding to the multiple brain-inspired applications to obtain the at least one group comprises:
calculating a vector distance between mapping vectors of any two brain-inspired applications in the initial application test suite;
performing clustering analysis on multiple brain-inspired applications in the initial application test suite according to the vector distance to obtain at least one initial group;
performing vector merging on mapping vectors of brain-inspired applications included in each initial group to obtain a feature vector corresponding to each initial group;
when the number of the at least one initial group is multiple, calculating a vector distance between feature vectors corresponding to any two initial groups among the multiple initial groups; and
performing clustering on the multiple initial groups based on the vector distance of the any two initial groups to obtain the at least one group.

10. An apparatus for determining a brain-inspired application test suite, comprising:
a feature extraction module configured to perform feature analysis on each brain-inspired application included in an initial application test suite to obtain a data representation feature corresponding to each brain-inspired application;
a computational overhead analysis module configured to compute a computational overhead generated when each brain-inspired application is executed based on a spiking neural network paradigm;
a feature determination module configured to determine a data computation feature corresponding to each brain-inspired application according to the computational overhead corresponding to each brain-inspired application;
a clustering module configured to perform clustering processing on the brain-inspired applications in the initial application test suite based on the data representation feature of each brain-inspired application and the data computation feature of each brain-inspired application to obtain at least one group; and
a test suite determination module configured to construct a brain-inspired application according to a feature vector corresponding to each group to obtain a target application test suite corresponding to the initial application test suite, wherein multiple brain-inspired applications in the target application test suite have orthogonality.

11. An electronic device, comprising: a processor and a memory storing computer program instructions; wherein the processor executes the computer program instructions to:
perform feature analysis on each brain-inspired application included in an initial application test suite to obtain a data representation feature corresponding to each brain-inspired application;
compute a computational overhead generated when each brain-inspired application is executed based on a spiking neural network paradigm;
determine a data computation feature corresponding to each brain-inspired application according to the computational overhead corresponding to each brain-inspired application;
perform clustering processing on the brain-inspired applications in the initial application test suite based on the data representation feature of each brain-inspired application and the data computation feature of each brain-inspired application to obtain at least one group; and
construct a brain-inspired application according to a feature vector corresponding to each group to obtain a target application test suite corresponding to the initial application test suite, wherein multiple brain-inspired applications in the target application test suite have orthogonality.

12. A non-transitory computer-readable storage medium having computer program instructions stored thereon, wherein the computer program instructions, when executed by a processor, implement the method for determining a brain-inspired application test suite according to claim 1.

13. A computer program product, wherein instructions in the computer program product, when executed by a processor of an electronic device, cause the electronic device to perform the method for determining a brain-inspired application test suite according to claim 1.
